(19) United States
(12) Patent Application Publication
(10) Pub. No.: US 2024/0171883 A1
(43) Pub. Date: May 23, 2024

(54) RADIATION IMAGING APPARATUS, METHOD FOR CONTROLLING THE SAME, AND STORAGE MEDIUM

(71) Applicant: CANON KABUSHIKI KAISHA, Tokyo (JP)

(72) Inventors: NAOTO SHIBATA, Kanagawa (JP); Kazumasa Matsumoto, Kanagawa (JP)

(21) Appl. No.: 18/510,365

(22) Filed: Nov. 15, 2023

(30) Foreign Application Priority Data
Nov. 17, 2022 (JP) 2022-184235

(51) Int. Cl. H04N 25/78; H04N 25/20; H04N 25/766

(52) U.S. Cl. CPC H04N 25/78; H04N 25/20; H04N 25/766

(57) ABSTRACT

A radiation imaging apparatus for performing moving image capturing, the radiation imaging apparatus includes a pixel array formed of a plurality of pixels arranged in a two-dimensional array form, each pixel having a signal generation unit for converting radiation into electric charges, a reading circuit configured to read a reset signal for generating a reset image and an accumulation signal according to accumulated electric charges, from the pixels of the pixel array, and one or more controllers configured to perform first control, perform second control, and perform, before starting the first control, third control for resetting the pixel array, wherein the third control resets the signal generation unit and subjects the pixel array from which the reset signal and the accumulation signal are read to internal scanning to apply a potential output by the signal generation unit in a reset state to signal lines in the pixel array.

### BACKGROUND OF THE DISCLOSURE

### Field of the Disclosure

The present disclosure relates to a radiation imaging apparatus, a method for controlling the radiation imaging apparatus, and a storage medium.

### Description of the Related Art

In the field of radiation imaging apparatuses, increasing number of large-area image sensors having photoelectric conversion elements arranged in a matrix form have been used to improve the resolution, reduce the volume, and prevent image distortions. Since noise is superposed in circuit elements in an image sensor, the image sensor needs to acquire a signal corresponding to the amount of received light while eliminating noise. In a period during which no signal is read from pixels, row signal lines connected to a scanning circuit and column signal lines as output lines of pixel circuits are floated. The signal lines as transmission lines on an element substrate have a larger capacitance than semiconductor elements. These floated signal lines having a large capacitance cause noise superposition, adversely affecting the image quality.

Japanese Patent Application Laid-Open No. 2012-99910 discusses a technique for stably reading noise superposed on an accumulation signal, by holding a reference potential in a holding circuit with reset drive, fixing the potential of signal lines with internal scanning for applying the held reference potential to signal lines, and reading the accumulation signal after the fixing. Japanese Patent Application Laid-Open No. 2019-62391 discusses a technique for reducing noise by generating frame images based on a reset image (generated by reading a reset signal output by a signal generation unit of each pixel after reset drive), a pre-generated image for fixed offset correction, and a radiation image based on an accumulation signal.

With the technique discussed in Japanese Patent Application Laid-Open No. 2019-62391, the reset image to be stably acquired may cause offset-related level variations depending on the irradiation state for the previous frame. To reduce offset-related level variations, it is effective to extend the reset period of reset drive from several hundreds of microseconds to several milliseconds to set the pixel array to a stable reset state. However, during this period, the amplifier in each pixel of the pixel array is turned ON, and a constant-current circuit in the pixel continues applying a constant current. This causes an issue that the power consumption increases resulting in heat generation in the pixel array. There arises another issue that the prolonged reset period limits the frame rate.

### SUMMARY OF THE DISCLOSURE

The present disclosure has been embodied in view of the above-described issues, and is directed to acquiring a stable reset image regardless of the irradiation state for the previous frame without prolonging the reset period.

According to an aspect of the present disclosure, a radiation imaging apparatus for performing moving image capturing, the radiation imaging apparatus includes a pixel array formed of a plurality of pixels arranged in a two-dimensional array form, each pixel having a signal generation unit for converting radiation into electric charges, a reading circuit configured to read a reset signal for generating a reset image and an accumulation signal according to accumulated electric charges, from the pixels of the pixel array, and one or more controllers configured to perform first control for resetting the signal generation unit and reading from each pixel the reset signal output by the signal generation unit in a reset state, perform, after performing the first control, second control for reading from each pixel the accumulation signal output by the signal generation unit according to accumulated electric charges, and perform, before starting the first control, third control for resetting the pixel array, wherein the third control resets the signal generation unit and subjects the pixel array from which the reset signal and the accumulation signal are read to internal scanning to apply a potential output by the signal generation unit in the reset state to signal lines in the pixel array.

Further features of the present disclosure will become apparent from the following description of exemplary embodiments with reference to the attached drawings.

### BRIEF DESCRIPTION OF THE DRAWINGS

FIG. 1 is an equivalent circuit diagram illustrating a pixel configuration according to the present exemplary embodiment.

FIG. 2 is an equivalent circuit diagram illustrating configurations of a pixel array and a signal reading unit according to the present exemplary embodiment.

FIG. 3 is a schematic view illustrating a configuration of a radiation imaging system according to the present exemplary embodiment.

FIG. 4 is a timing chart illustrating an example of a driving method according to the first exemplary embodiment.

FIG. 5 is a timing chart illustrating an example of a driving method according to a second exemplary embodiment.

### DESCRIPTION OF THE EMBODIMENTS

Exemplary embodiments of the present disclosure will be described below with reference to the accompanying drawings. The following exemplary embodiments do not limit the present disclosure. Although a plurality of features is described in the exemplary embodiments, not all of the plurality of features is indispensable to the present disclosure, and the plurality of features may be combined in any desired way. In the accompanying drawings, identical or similar components are assigned the same reference numerals, and duplicated descriptions thereof will be omitted.

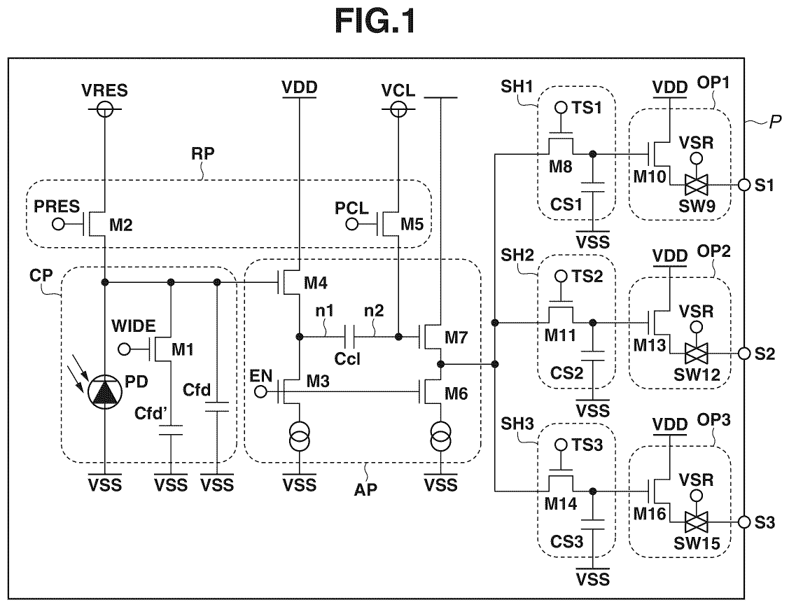

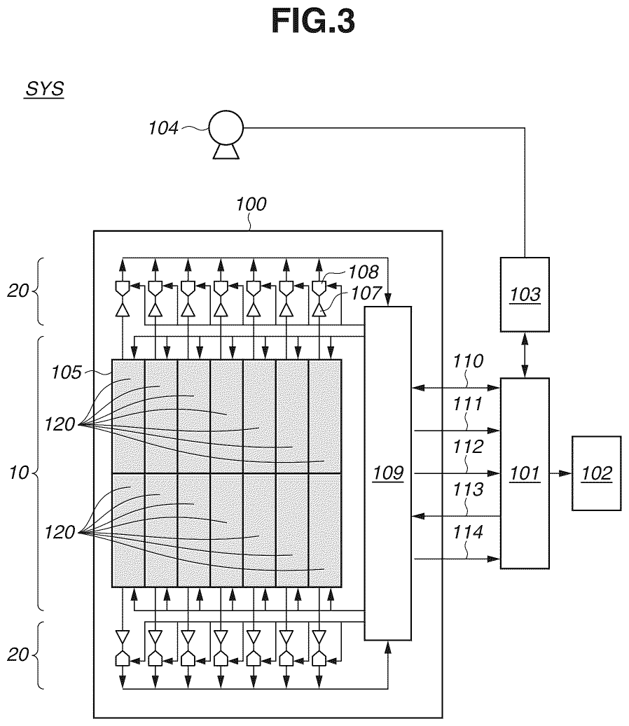

FIG. 1 is an equivalent circuit diagram illustrating a schematic circuit of one pixel P in a radiation imaging apparatus 100 (FIG. 3) according to a first exemplary embodiment of the present disclosure. The pixel P includes a conversion unit CP, an amplifier AP, a reset unit RP, holding units SH1 to SH3, and output units OP1 to OP3. In the following examples, each of these components is formed of a circuit.

The conversion unit CP includes a photodiode PD, a transistor M1, and a floating diffusion capacitor Cfd (hereinafter referred to as an FD capacitor Cfd). A capacitor Cfd′ denotes an additional capacitor for sensitivity change. However, according to the present exemplary embodiment, the capacitor Cfd′ is not used by setting the transistor M1 to a nonconductive state by using a WIDE signal. The photodiode PD as an example of a photoelectric conversion element converts light generated by radiation incident on the scintillator as a wavelength converter into electric charges. An amount of electric charges corresponding to incident radiation is generated by the photodiode PD, and a voltage of the FD capacitor Cfd corresponding to generated electric charges is output to the amplifier AP.

The amplifier AP amplifies the voltage from the conversion unit CP. The amplifier AP includes a control transistor M3, an amplifying transistor M4, a clamp capacitor Ccl, a control transistor M6, an amplifying transistor M7, and constant-current power sources. The control transistors M3, the amplifying transistor M4, and the constant-current power source (e.g., transistor having the current mirror configuration) are connected in series to form a current path. When an enable signal EN input to the gate of the control transistors M3 is activated, the amplifying transistor M4 receiving the voltage from the conversion unit CP becomes active. A source follower circuit is formed in this way, and the voltage from the conversion unit CP is amplified and output by the amplifying transistor M4. The voltage output from the amplifying transistor M4 is input to the amplifying transistor M7 via the clamp capacitor Ccl. The control transistors M6, the amplifying transistor M7, and a constant-current power source are connected in series to form a current path. When the enable signal EN input to the gate of the control transistors M6 is activated, the amplifying transistor M7 receiving the voltage from the amplifying transistor M4 becomes active. A source follower circuit is formed in this way, and the voltage from the amplifying transistor M4 is amplified and output by the amplifying transistor M7. The clamp capacitor Ccl is disposed in serial between the amplifying transistor M4 and the amplifying transistor M7.

The reset unit RP includes reset transistors M2 and M5.

When a reset signal PRES is activated, the reset transistor M2 supplies a predetermined potential to the photodiode PD, which resets (initializes) electric charges of the photodiode PD to reset the voltage output to the amplifier AP. The reset transistor M5 supplies a predetermined potential to the connection node between the clamp capacitor Ccl and the amplifying transistor M7 to reset the voltage output from the amplifying transistor M7. A voltage corresponding to the voltage from the conversion unit CP at the time of resetting by the reset transistor M2 is input to an input terminal n1 of the clamp capacitor Ccl. When a clamp signal PCL is activated, the reset transistor M5 becomes conductive, and the clamp voltage VCL as a predetermined potential is input to an output terminal n2 of the clamp capacitor Ccl. Thus, the potential difference occurring between the two terminals of the clamp capacitor Cel is clamped as a noise component, and the voltage changed with the subsequent generation and accumulation of electric charges in the photodiode PD is output as a signal component. This is a clamp operation using the clamp capacitor Ccl, which restricts noise components such as kTC noise occurring in the conversion unit CP and an offset of the amplifying transistor M4.

The conversion unit CP and the amplifier AP configure a signal generation unit for converting radiation into electric charges to generate a signal based on electric charges accumulated in the conversion unit CP. The signal according to accumulated electric charges is referred to as an accumulation signal. Electric charge accumulated in the conversion unit CP includes electric charges generated according to radiation and electric charges (dark electric charges) generated regardless of radiation. The signal generated by the signal generation unit when the reset unit RP resets the signal generation unit to the state before the electric charge accumulation is referred to as a reset signal. The accumulation signal and the reset signal are collectively referred to as pixel signals. The accumulation signal refers to the pixel signal output by the signal generation unit after the electric charge accumulation in the conversion unit CP. The reset signal refers to the pixel signal output when the signal generation unit is in the reset state.

The holding unit SH1 can hold the pixel signal output from the amplifier AP. The holding unit SH1 is a sample-and-hold circuit including a transfer transistor M8 and a holding capacitor CS1. The holding unit SH1 changes the state of the transfer transistor M8 (conductive or nonconductive state) by using a sample-and-hold control signal TS1 to transfer the pixel signal to the capacitor CS1 to hold the signal for sampling.

The holding unit SH2 can hold the pixel signal output from the amplifier AP. The holding unit SH2 is a sample-and-hold circuit including a transfer transistor M11 and a holding capacitor CS2. The holding unit SH2 changes the state of the transfer transistor M11 (conductive or nonconductive state) by using a sample-and-hold control signal TS2 to transfer the pixel signal to the capacitor CS2 to hold the signal for sampling.

The holding unit SH3 can hold the pixel signal output from the amplifier AP. The holding unit SH3 is a sample-and-hold circuit including a transfer transistor M14 and a holding capacitor CS3. The holding unit SH3 changes the state of the transfer transistor M14 (conductive or nonconductive state) by using a sample-and-hold control signal TS3 to transfer the pixel signal to the capacitor CS3 to hold the signal for sampling.

The output unit OP1 includes a signal amplifying transistor M10 and an output switch SW9. The signal amplifying transistor M10 amplifies and outputs the pixel signal held by the holding capacitor CS1. The output switch SW9 transfers the pixel signal output by the signal amplifying transistor M10. When the output switch SW9 becomes conductive by a vertical scanning signal VSR input to the output switch SW9, a source follower circuit is formed by a constant-current power source CCSp in the following stage connected with a column signal line 406 and the signal amplifying transistor M10. Thus, the pixel signal held by the holding unit SH1 is amplified and output from the pixel P by the output unit OP1. Hereinafter, the amplified pixel signal output from the output unit OP1 of the pixel P is referred to as a pixel signal S1.

The output unit OP2 includes a signal amplifying transistor M13 and an output switch SW12. The signal amplifying transistor M13 amplifies and outputs the pixel signal held by the holding capacitor CS2. The output switch SW12 transfers the pixel signal output by the signal amplifying transistor M13. When the output switch SW12 becomes conductive by the vertical scanning signal VSR input to the output switch SW12, a source follower circuit is formed by the constant-current power source CCSp in the following stage connected with a column signal line 407 and the signal amplifying transistor M13. Thus, the pixel signal held by the holding unit SH2 is amplified and output from the pixel P by the output unit OP2. Hereinafter, the amplified pixel signal output from the output unit OP2 of the pixel P is referred to as a pixel signal S2.

The output unit OP3 includes a signal amplifying transistor M16 and an output switch SW15. The signal amplifying transistor M16 amplifies and outputs the pixel signal held by the holding capacitor CS3. The output switch SW15 transfers the pixel signal output by the signal amplifying transistor M16. When the output switch SW15 becomes conductive by the vertical scanning signal VSR input to the output switch SW15, a source follower circuit is formed by the constant-current power source CCSp in the following stage connected with a column signal line 408 and the signal amplifying transistor M16. Thus, the pixel signal held by the holding unit SH3 is amplified and output from the pixel P by the output unit OP3. Hereinafter, the amplified pixel signal output from the output unit OP3 of the pixel P is referred to as a pixel signal S3.

After the capacitors CS1, CS2, and CS3 have been sampled and held, the transfer transistors M8, M11, and M14 turn OFF, and accordingly the capacitors CS1, CS2, and CS3 are disconnected from the amplifier AP in the preceding stage. Therefore, the held pixel signal (accumulation signal or reset signal) can be read out in a nondestructive way until it is sampled and held again.

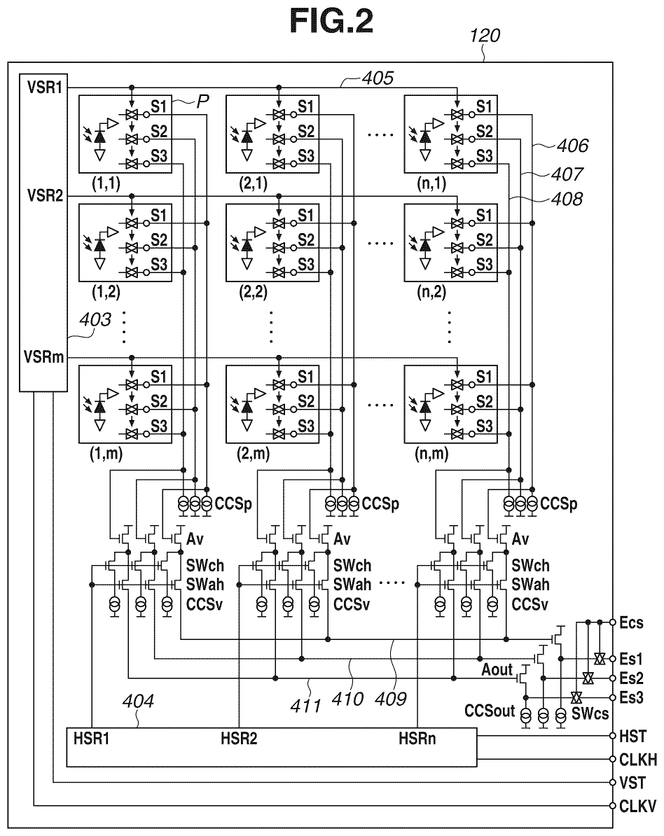

A pixel array 120 of the radiation imaging apparatus 100 according to the present exemplary embodiment will be described below with reference to FIG. 2. The pixel array 120 is formed of a plurality of the pixels P in FIG. 1 arranged in a two-dimensional array form. Signals from the pixel array 120 are read by reading circuits 20 (FIG. 3). FIG. 2 is an equivalent circuit diagram illustrating an overall configuration of the pixel array 120 of the radiation imaging apparatus 100 according to the present exemplary embodiment.

The pixel array 120 includes a plurality of the two-dimensionally arranged pixels P, a vertical scanning circuit 403 for driving the pixels P, and a horizontal scanning circuit 404 for reading signals from the pixels P. The vertical scanning circuit 403 and the horizontal scanning circuit 404 operate based on control signals from a control unit 109 (FIG. 3). The vertical scanning circuit 403 functions as a row selection unit and performs vertical scanning to select the pixels P subjected to signal reading on a row basis. The horizontal scanning circuit 404 functions as a column selection unit and performs horizontal scanning for signal output by sequentially and horizontally selecting column signal lines subjected to pixel signal output from each pixel P in the pixel row selected by the vertical scanning circuit 403.

The pixel array 120 includes a terminal Es1 for reading the pixel signal held by the capacitor CS1 of each pixel P, a terminal Es2 for reading the pixel signal held by the capacitor CS2, and a terminal Es3 for reading the pixel signal held by the capacitor CS3. The pixel array 120 also includes a selection terminal Ecs. When the signal received by the terminal Ecs is activated, the pixel signals of each pixel P in the pixel array 120 are read via the terminals Es1, Es2 and Es3. More specifically, the pixel signals S1, S2, and S3 of each pixel P are supplied to the column signal lines 406, 407, and 408 corresponding to the terminals Es1, Es2, and Es3, respectively.

A control transistor SWch, an amplifying transistor Av, and a constant-current power source CCSv are connected in series to form a current path. The outputs of the amplifying transistors Av are connected to analog output signal lines 409, 410, and 411 via transfer transistors SWah that become conductive in response to a horizontal scanning signal HSR from the horizontal scanning circuit 404. When the horizontal scanning signal HSR input to the gates of the control transistors SWch is activated, the amplifying transistors Av receiving voltages from the column signal lines 406 to 408 become active. A source follower circuit is formed in this way. The voltages from the column signal lines 406 to 408 are amplified and output to the analog output signal lines 409 to 411, respectively, via the transfer transistors SWah that become conductive in response to the horizontal scanning signal HSR.

An amplifying transistor Aout and a constant-current power source CCSout are connected in series to form a current path, and an active source follower circuit is formed. Voltages from the analog output signal lines 409, 410, and 411 are amplified and output from the terminals Es1, Es2 and Es3, respectively, via transfer transistors SWcs that become conductive in response to the signal received by the terminal Ecs.

The pixel array 120 includes terminals HST, CLKH, VST, and CLKV for receiving control signals for controlling the vertical scanning circuit 403 and the horizontal scanning circuit 404. The terminal HST receives a horizontal scanning start pulse HST to be input to the horizontal scanning circuit 404. The terminal CLKH receives a horizontal clock signal CLKH to be input to the horizontal scanning circuit 404. The terminal VST receives a vertical scanning start pulse VST to be input to the vertical scanning circuit 403. The terminal CLKV receives a vertical clock signal CLKV to be input to the vertical scanning circuit 403. These control signals are input from the control unit 109 (described below with reference to FIG. 3).

The vertical scanning circuit 403 generates and outputs the vertical scanning signals VSR based on the input vertical scanning start pulse VST and the clock signal CLKV. The horizontal scanning circuit 404 generates and outputs the horizontal scanning signals HSR based on the input horizontal scanning start pulse HST and the clock signal CLKH. Thus, the reset signal or the accumulation signal is sequentially read as a pixel signal from each pixel based on the XY address method. Hereinafter, the term “reading” refers to an operation for sequentially reading pixel signals based on the XY address method by the vertical scanning circuit 403 and the horizontal scanning circuit 404.

The radiation imaging apparatus 100 and a radiation imaging system SYS according to the present exemplary embodiment are configured by using the thus-configured pixel array 120. The radiation imaging apparatus 100 and the radiation imaging system SYS according to the present exemplary embodiment will be described below with reference to FIG. 3. FIG. 3 schematically illustrates an overall configuration of the radiation imaging apparatus 100 and the radiation imaging system SYS according to the present exemplary embodiment.

The radiation imaging system SYS includes the radiation imaging apparatus 100, a radiation generation apparatus 104 for generating radiation, a radiation control unit 103, a signal processing unit 101 for performing image processing and system control, and a display unit 102 including a display. When performing radiation imaging, the signal processing unit 101 subjects the radiation imaging apparatus 100 and the radiation control unit 103 to synchronization control. The radiation imaging apparatus 100 generates signals based on radiation (such as X-ray, alpha ray, beta ray, and gamma ray) that has passed through a subject. Then, the signal processing unit 101 subjects the signals to predetermined processing to generate image data based on the radiation. The image data is displayed as a radiation image on the display unit 102. The radiation imaging apparatus 100 includes an imaging panel 105 having an imaging region 10, a reading circuit 20 for reading signals from the imaging region 10, and the control unit 109 for controlling each unit.

The large imaging panel 105 is formed of a plurality of the pixel arrays 120 two-dimensionally arranged in a tile form on a plate-like base. Each pixel array 120 includes a plurality of the pixels P. The imaging region 10 includes a plurality of the pixels P arranged to form a row and a plurality of columns by using a plurality of the pixel arrays 120. Although FIG. 3 illustrates an example of a configuration in which a plurality of the pixel arrays 120 is arranged in a tile form to form a 2×7 (two rows by seven columns) matrix, the present disclosure is not limited to this configuration.

For example, the control unit 109 communicates control commands and synchronization signals with the signal processing unit 101, and outputs image data to the signal processing unit 101. The control unit 109 may include a processor such as a Central Processing Unit (CPU) and memories such as a Random Access Memory (RAM) and a Read Only Memory (ROM). The processor of the control unit 109 may execute programs stored in the memories to enable the operations of the radiation imaging apparatus 100 (described below). Instead, the control unit 109 may include a dedicated circuit such as an Application Specific Integrated Circuit (ASIC). Likewise, the signal processing unit 101 may be a computer including a processor such as a CPU and memories such as a RAM and ROM or may include a dedicated circuit such as an ASIC.

Control commands or control signals and image data are exchanged between the control unit 109 and the signal processing unit 101 via various interfaces. The signal processing unit 101 outputs imaging information or setting information including the operation mode and various parameters to the control unit 109 via a control interface 110. The control unit 109 also outputs apparatus information including operation statuses of the radiation imaging apparatus 100 to the signal processing unit 101 via the control interface 110.

The control unit 109 also outputs image data obtained by the radiation imaging apparatus 100 to the signal processing unit 101 via an image data interface 111. The control unit 109 also notifies the signal processing unit 101 that the radiation imaging apparatus 100 has entered a state ready for imaging, by using a READY signal 112. The signal processing unit 101 also outputs a SYNC signal 113 as an imaging synchronization signal to the control unit 109 to notify the control unit 109 of the timing of starting the radiation irradiation. When the control unit 109 detects the rising edge of the pulse in the SYNC signal 113, the control unit 109 starts the drive for generating frame images. A radiation permission signal 114 notifies the signal processing unit 101 that the imaging panel 105 is currently accumulating the accumulation signal. While the radiation permission signal 114 is enabled, the signal processing unit 101 outputs a control signal to the radiation control unit 103 to start the radiation irradiation.

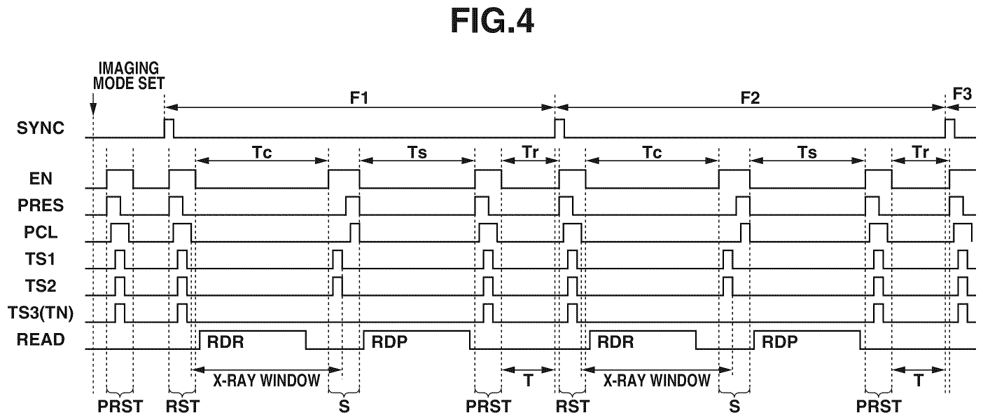

FIG. 4 is a timing chart illustrating an example of a driving method according to the first exemplary embodiment. FIG. 4 illustrates an example of drive control for stabilizing a reset image at the time of moving image capturing by the radiation imaging apparatus 100. The drive illustrated in FIG. 4 is performed when the control unit 109 controls the operations of different components of the radiation imaging apparatus 100. The radiation imaging apparatus 100 performs moving image capturing to sequentially generate frame images. A reset image refers to an image generated based on the reset signal read from each pixel.

Referring to FIG. 4, “SYNC”, “EN”, “PRES”, “PCL”, “TS1”, “TS2”, and “TS3 (TN)” denote signal levels. Referring to FIG. 4, the reset signal is read in a period RDR during which READ is set to the high level, and the accumulation signal is read in the period RDP during which READ is set to the high level.

Referring to the timing chart illustrated in FIG. 4, when the signal processing unit 101 initially sets the imaging mode to the radiation imaging apparatus 100, the radiation imaging apparatus 100 sets the imaging mode. After setting the imaging mode, the radiation imaging apparatus 100 performs pre-reset drive PRST and then waits for the start of imaging. In the pre-reset drive PRST, the radiation imaging apparatus 100 activates the enable signal EN, the reset signal PRES, and the clamp signal PCL to the high level to reset the conversion unit CP (photoelectric conversion unit) and the amplifier AP (clamp circuit). After the sample-and-hold control signals TS1, TS2, and TS3 (TN) are activated to the high level, the radiation imaging apparatus 100 samples the reset potential and holds it in the holding units SH1, SH2, and SH3. This pre-reset drive PRST is an example of third control.

When the radiation imaging apparatus 100 detects the rising edge of an imaging synchronization signal SYNC, the apparatus 100 starts imaging drive F1 for generating the frame image of the first frame. Initially, the radiation imaging apparatus 100 performs reset drive RST. In the reset drive RST, the radiation imaging apparatus 100 activates the enable signal EN, the reset signal PRES, and the clamp signal PCL to the high level to reset the conversion unit CP (photoelectric conversion unit) and the amplifier AP (clamp circuit). After the sample-and-hold control signals TS1, TS2, and TS3 (TN) are activated to the high level, the holding units SH1, SH2, and SH3 sample and hold the reset potential.

After the reset drive RST, the radiation imaging apparatus 100 reads the reset signal based on the reset potential sampled and held by the holding units SH1, SH2, and SH3 in the period RDR, and generates a reset image based on the read reset signal. In the period RDR, the radiation imaging apparatus 100 selectively activates the vertical scanning signals VSR and the horizontal scanning signals HSR and sequentially scans the pixels P of the pixel array 120, and then the reset signal is read from each pixel P. The above-described reset drive RST and control in the period RDR are examples of first control.

When a period Tc corresponding to preset accumulation time has elapsed since the end of the reset drive RST, the radiation imaging apparatus 100 starts sample-and-hold drive S for sampling the accumulation signal accumulated in the conversion unit CP and holding the signal in the holding units SH1, SH2, and SH3. In the sample-and-hold drive S, initially, the enable signal EN and the sample-and-hold control signals TS1 and TS2 are activated to the high level. In the period during which the sample-and-hold control signals TS1 and TS2 are set to the high level, the radiation imaging apparatus 100 samples the accumulation signal accumulated in the conversion unit CP and holds the signal in the holding units SH1 and SH2. After setting the sample-and-hold control signals TS1 and TS2 to the low level, the radiation imaging apparatus 100 activates the reset signal PRES and the clamp signal PCL to the high level to reset the conversion unit CP (photoelectric conversion unit) and the amplifier AP (clamp circuit). Then, the radiation imaging apparatus 100 sets the enable signal EN, the reset signal PRES, and the clamp signal PCL to the low level to complete the sample-and-hold drive S.

In the period Ts after completing the sample-and-hold drive S, the radiation imaging apparatus 100 reads the accumulation signal sampled and held in the holding units SH1 and SH2 in the period RDP. In the period RDP, the radiation imaging apparatus 100 selectively activates the vertical scanning signals VSR and the horizontal scanning signals HSR to sequentially scan the pixels P of the pixel array 120 to read the accumulation signal from each pixel P. Referring to the example illustrated in FIG. 4, the radiation imaging apparatus 100 holds the accumulation signals in the two holding units SH1 and SH2 in the sample-and-hold drive S. Only one of the accumulation signals read from the holding units SH1 and SH2 is used in the following stage. The radiation imaging apparatus 100 generates frame images based on a read accumulation signal, an image for fixed offset correction acquired before generating the captured image at the time of the radiation irradiation, and the reset image. The image for fixed offset correction is an image for correction to be used to correct fixed pattern noise (FPN) generated based on the accumulation image (generated in a state where no radiation is irradiated before starting imaging) and the reset image generated in this state. The above-described sample-and-hold drive S and control in the period RDP are examples of second control.

When the accumulation signal reading is completed, the radiation imaging apparatus 100 performs the pre-reset drive PRST to prepare for the next imaging. In the pre-reset drive PRST, the radiation imaging apparatus 100 activates the enable signal EN, the reset signal PRES, and the clamp signal PCL to the high level to reset the conversion unit CP (photoelectric conversion unit) and the amplifier AP (clamp circuit). After the sample-and-hold control signals TS1. TS2, and TS3 (TN) are activated to the high level, the radiation imaging apparatus 100 samples the reset potential and holds it in the holding units SH1, SH2, and SH3. This pre-reset drive PRST is an example of third control. The drive time of the pre-reset drive PRST may be equivalent to that of the reset drive RST, or the drive time of the pre-reset PRST may be reduced to be shorter than that of the reset drive RST. Generally, when a time period T corresponding to the frame rate of several milliseconds to several tens of milliseconds has elapsed, the imaging synchronization signal SYNC rises, and the radiation imaging apparatus 100 starts imaging drive F2 for generating the next frame image (frame image of the second frame). Likewise, the radiation imaging apparatus 100 performs imaging drive for generating frame images.

According to the present exemplary embodiment, the radiation imaging apparatus 100 performs the pre-reset drive PRST before performing the reset drive RST of the top portion of the imaging drive for generating frame images. When the radiation imaging apparatus 100 performs the pre-reset drive PRST, the pixel array 120 is reset. This is substantially equivalent to an event that the radiation imaging apparatus 100 continues the reset drive for a prolonged time period since the pre-reset drive PRST starts till the reset drive RST ends. More specifically, the reset potential enables securing time until the pixel array 120 enters the stable reset state. This enables the radiation imaging apparatus 100 to constantly acquire a stable reset image regardless of the irradiation state for the previous frame, enabling favorable reset image correction. In the time period since the pre-reset drive PRST ends till the reset drive RST starts, the power consumption can be restrained by turning OFF the control signal EN to stop the power supply to the amplifiers in the pixels of the pixel array 120.

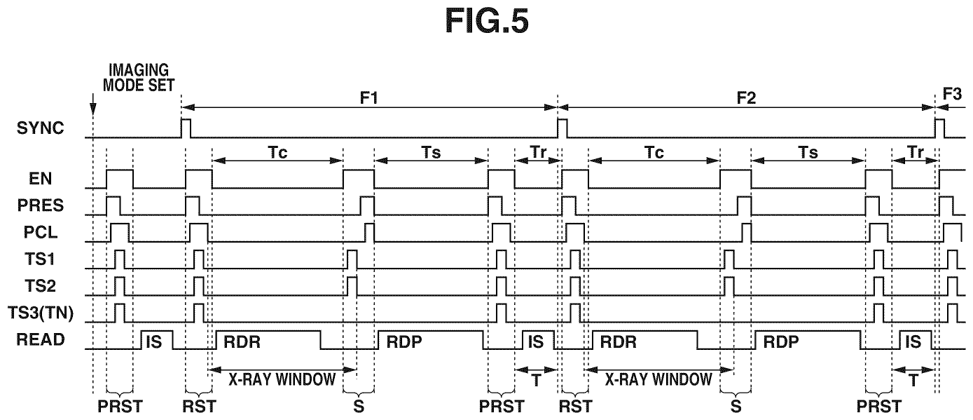

A second exemplary embodiment differs from the first exemplary embodiment in the driving method, and is similar to the first exemplary embodiment in other points. Descriptions of similar points will be omitted, and the driving method according to the second exemplary embodiment will be described below. FIG. 5 is a timing chart illustrating an example of a driving method according to the second exemplary embodiment. FIG. 5 illustrates an example of drive control for stabilizing reset images at the time of moving image capturing by the radiation imaging apparatus 100.

Referring to FIG. 5, “SYNC”, “EN”, “PRES”, “PCL”, “TS1”, “TS2”, and “TS3 (TN)” denote signal levels. Referring to FIG. 5, the radiation imaging apparatus 100 reads the reset signal in the period RDR during which READ is set to high level, reads the accumulation signal in the period RDP, and performs internal scanning for applying the reset potential held in the holding units SH1, SH2, and SH3 in the period IS to the signal lines.

Hereinafter, the second exemplary embodiment will be described below centering on differences from the first exemplary embodiment. According to the second exemplary embodiment, as illustrated in FIG. 5, the radiation imaging apparatus 100 performs the internal scanning IS in a time period since the pre-reset drive PRST ends till the subsequent reset drive RST starts in the imaging drive for generating frame images.

In the internal scanning IS, the radiation imaging apparatus 100 sequentially turns ON the transfer transistor M8 of the holding unit SH1 and the output switch SW9 of the output unit OP1 to apply the sampled and held reset potential to the column signal line 406 and the analog output signal line 409. More specifically, the radiation imaging apparatus 100 applies the voltage of the reset signal sampled and held by the capacitor CS1 of the holding unit SH1 to the column signal line 406 and the analog output signal line 409. Likewise, the radiation imaging apparatus 100 sequentially turns ON the transfer transistors M11 and M14 of the holding units SH2 and SH3 and the output switches SW12 and SW15 of the output units OP2 and OP3, respectively, to apply the reset potentials to the corresponding column signal lines 407 and 408 and the corresponding analog output signal lines 410 and 411, respectively.

To scan the reading circuit in the internal scanning IS, the radiation imaging apparatus 100 sets the vertical scanning start pulse VST to the high level, continuously inputs the vertical clock signal CLKV, and sequentially sets internal row selection lines 405 to the logic potential as the initial potential. As the row selection lines 405 are sequentially set to the initial potential, the column signal lines 406, 407, and 408 of the column signal line reading circuit and the analog output signal lines 409, 410, and 411 are fixed to the reset potential. According to present exemplary embodiments, the horizontal scanning during the vertical scanning is not mandatory.

To set indefinite potential in the reading circuit to the reset potential, the radiation imaging apparatus 100 needs to perform the internal scanning for the reading system in a state where the reset potential is held in the holding units SH1, SH2, and SH3 and does not need to output the signal voltage read from each pixel to an analog-to-digital (A/D) converter. When the radiation imaging apparatus 100 performs the pre-reset drive PRST and then the internal scanning, the column signal lines 406, 407, and 408 and the analog output signal lines 409, 410, and 411 of the reading circuit based on the XY address scanning method are fixed to the reset potential.

The driving method according to the first exemplary embodiment generally requires time T from several milliseconds to several tens of milliseconds until the pixel array 120 becomes stable after the pre-reset drive PRST is performed.

When performing high frame rate imaging with a reduced frame rate or imaging with the wide X-Ray Window, the time permitted as the time T is limited to several milliseconds or less. In this case, it becomes difficult to secure time until the pixel array 120 becomes internally stable.

To further improve the acquisition of stable reset images, the second exemplary embodiment performs the pre-reset drive PRST and then the internal scanning IS for forcibly setting the signal lines to be floated in the pixel array 120 to the reset potential. By applying the reset potential to the reading circuit in the pixel array 120 through the internal scanning IS, the radiation imaging apparatus 100 can reduce the total time duration of the pre-reset drive PRST and the internal scanning IS to 1 millisecond or less, thus reducing the time required to stabilize the pixel array 120. This enables alleviating the limitations on the frame rate and supporting imaging with a high frame rate and imaging with a wide X-Ray Window.

### (Other Exemplary Embodiments of Present Disclosure)

The disclosure of the present exemplary embodiment includes the following configurations and methods.

### (Configuration 1)

There is provided a radiation imaging apparatus for performing moving image capturing. The apparatus includes a pixel array formed of a plurality of pixels arranged in a two-dimensional array form, each pixel having a signal generation unit for converting radiation into electric charges. The apparatus further includes a reading unit configured to read a reset signal for generating a reset image and an accumulation signal according to accumulated electric charges, from the pixels of the pixel array. The apparatus further includes a control unit configured to perform first control for resetting the signal generation unit and reading from each pixel the reset signal output by the signal generation unit in a reset state, perform, after performing the first control, second control for reading from each pixel the accumulation signal output by the signal generation unit according to accumulated electric charges, and perform, before starting the first control, third control for resetting the pixel array.

### (Configuration 2)

The radiation imaging apparatus according to configuration 1 in which in the third control, the apparatus resets the signal generation unit.

### (Configuration 3)

The radiation imaging apparatus according to configuration 2 in which in the third control, the apparatus applies a predetermined potential to signal lines in the pixel array from which the reset signal and the accumulation signal are read.

### (Configuration 4)

The radiation imaging apparatus according to configuration 3 in which the apparatus applies, as the predetermined potential, a potential output by the signal generation unit in the reset state to the signal lines by performing internal scanning of the pixel array.

### (Configuration 5)

The radiation imaging apparatus according to any one of configurations 1 to 4 in which the apparatus further includes a generating unit configured to generate frame images based on the reset signal read from each pixel in the first control and the accumulation signal read from each pixel in the second control.

### (Method 1)

There is provided a method for controlling a radiation imaging apparatus for performing moving image capturing, having a pixel array formed of a plurality of pixels arranged in a two-dimensional array form, each pixel having a signal generation unit for converting radiation into electric charges. The method includes performing first control for resetting the signal generation unit and reading from each pixel a reset signal for generating a reset image output by the signal generation unit in a reset state. The method further includes performing, after performing the first control, second control for reading from each pixel an accumulation signal output by the signal generation unit according to accumulated electric charges. The method further includes performing, before starting the first control, third control for resetting the pixel array.

### (Program 1)

There is provided a program for causing a computer of a radiation imaging apparatus to execute a method. The radiation imaging apparatus performs moving image capturing, having a pixel array formed of a plurality of pixels arranged in a two-dimensional array form, each pixel having a signal generation unit for converting radiation into electric charges. The method includes performing first control for resetting the signal generation unit and reading from each pixel a reset signal for generating a reset image output by the signal generation unit in a reset state. The method further includes performing, after performing the first control, second control for reading from each pixel the accumulation signal output by the signal generation unit according to accumulated electric charges. The method further includes performing, before starting the first control, third control for resetting the pixel array.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-184235, filed Nov. 17, 2022, which is hereby incorporated by reference herein in its entirety.

What is claimed is:

1. A radiation imaging apparatus for performing moving image capturing, the radiation imaging apparatus comprising:
a pixel array formed of a plurality of pixels arranged in a two-dimensional array form, each pixel having a signal generation unit for converting radiation into electric charges;
a reading circuit configured to read a reset signal for generating a reset image and an accumulation signal according to accumulated electric charges, from the pixels of the pixel array; and
one or more controllers configured to:
perform first control for resetting the signal generation unit and reading from each pixel the reset signal output by the signal generation unit in a reset state;
perform, after performing the first control, second control for reading from each pixel the accumulation signal output by the signal generation unit according to accumulated electric charges; and
perform, before starting the first control, third control for resetting the pixel array,
wherein the third control resets the signal generation unit and subjects the pixel array from which the reset signal and the accumulation signal are read to internal scanning to apply a potential output by the signal generation unit in the reset state to signal lines in the pixel array.

2. The radiation imaging apparatus according to claim 1, wherein the one or more controllers being configured to generate frame images based on the reset signal read from each pixel in the first control and the accumulation signal read from each pixel in the second control.

3. A method for controlling a radiation imaging apparatus for performing moving image capturing, having a pixel array formed of a plurality of pixels arranged in a two-dimensional array form, each pixel having a signal generation unit for converting radiation into electric charges, the control method comprising:
performing first control for resetting the signal generation unit and reading from each pixel a reset signal for generating a reset image output by the signal generation unit in a reset state;
performing, after performing the first control, second control for reading from each pixel an accumulation signal output by the signal generation unit according to accumulated electric charges; and
performing, before starting the first control, third control for resetting the pixel array,
wherein the third control resets the signal generation unit and subjects the pixel array from which the reset signal and the accumulation signal are read to internal scanning to apply a potential output by the signal generation unit in the reset state to signal lines in the pixel array.

4. The control method according to claim 3, further comprising: generating frame images based on the reset signal read from each pixel in the first control and the accumulation signal read from each pixel in the second control.

5. A non-transitory computer-readable storage medium storing a program for causing a computer of a radiation imaging apparatus to execute a method, the radiation imaging apparatus performing moving image capturing, having a pixel array formed of a plurality of pixels arranged in a two-dimensional array form, each pixel having a signal generation unit for converting radiation into electric charges, the method comprising:
performing first control for resetting the signal generation unit and reading from each pixel a reset signal for generating a reset image output by the signal generation unit in a reset state;
performing, after performing the first control, second control for reading from each pixel an accumulation signal output by the signal generation unit according to accumulated electric charges; and
performing, before starting the first control, third control for resetting the pixel array,
wherein the third control resets the signal generation unit and subjects the pixel array from which the reset signal and the accumulation signal are read to internal scanning to apply a potential output by the signal generation unit in the reset state to signal lines in the pixel array.

6. The non-transitory computer-readable medium according to claim 5, the method further comprising: generating frame images based on the reset signal read from each pixel in the first control and the accumulation signal read from each pixel in the second control.
